(19) United States
(12) Patent Application Publication
(10) Pub. No.: US 2018/0166950 A1
(43) Pub. Date: Jun. 14, 2018

(54) Cooling Structure for Drive Motor

(71) Applicants: Hyundai Motor Company, Seoul (KR); Kia Motors Corporation, Seoul (KR)

(72) Inventors: Jungwoo Lee, Hwaseong-si (KR); Dongyeon Han, Seoul (KR)

(21) Appl. No.: 15/622,979

(22) Filed: Jun. 14, 2017

(30) Foreign Application Priority Data
Dec. 9, 2016 (KR) 10-2016-0167906

(51) Int. Cl. H02K 9/19; H02K 5/20

(52) U.S. Cl. CPC H02K 9/19; H02K 5/20

(57) ABSTRACT

A cooling apparatus of a drive motor according to an exemplary embodiment of the present invention may include a supporter that is disposed in an inner wall of a housing, supports a stator of the drive motor, and forms an oil passage for moving cooling oil. The supporter can be formed as a ring shape. An injector is connected with the oil passage of the supporter and injects the cooling oil in the oil passage into the stator.

### CROSS-REFERENCE TO RELATED APPLICATIONS

This application claims priority to and the benefit of Korean Patent Application No. 10-2016-0167906 filed in the Korean Intellectual Property Office on Dec. 9 2016, the entire contents of which are incorporated herein by reference.

### TECHNICAL FIELD

The present invention relates to a drive motor.

### BACKGROUND

In general, a hybrid vehicle or an electric vehicle, called an eco-friendly vehicle, may generate driving power with an electric motor (hereinafter called “drive motor”) which obtains torque from electrical energy.

The drive motor includes a stator and a rotor. The stator is disposed in a motor housing, and the rotor is disposed at a predetermined air gap therefrom at the inside of the stator. The stator includes a stator core made of an electric steel plate and a coil wound around the stator core.

Meanwhile, in the drive motor of concentrated winding split core type, a large amount of heat is generated in the stator coil by current supplied to the stator coil. Accordingly, in order to prevent damage to the drive motor due to the heat and to continuously ensure stable operability, substantial cooling should be performed.

Particularly, cooling of the drive motor such as a permanent magnet synchronous motor (PMSM) is very important for motor efficiency and protection of key components (for example, permanent magnet, coil, etc.). Cooling of the drive motor is major factor that determines performance and efficiency of the drive motor. In other words, the permanent magnet and the coil of the drive motor affect the performance of the motor according to temperature.

A scheme for cooling the drive motor includes an oil cooling scheme using oil and a water cooling scheme using water. According to the oil cooling scheme using oil, the stator core is fixed to a motor housing and a support ring for cooling the stator core is disposed between the stator core and the motor housing.

Therefore, heat generated in the drive motor is transferred to the support ring through the stator core and dissipated to outside through the support ring. At this time, oil flows through a channel formed in the support ring such that heat dissipation amount is maximized and the drive motor is cooled.

However, according to the conventional oil cooling scheme, since the drive motor is indirectly cooled by the oil circulating the channel in the support ring, improvement of cooling performance of the drive motor is limited.

Further, according to conventional art, cooling area of the support ring should be increased in order to improve cooling performance of the drive motor. But if the cooling area of the support ring is increased, size of the drive motor is increased and torque density of the drive motor and mountability are decreased.

The above information disclosed in this Background section is only for enhancement of understanding of the background of the invention and therefore it may contain information that does not form the prior art that is already known in this country to a person of ordinary skill in the art.

### SUMMARY

Embodiments of the present invention relate to a drive motor for an environmentally-friendly vehicle. In particular embodiments, the present invention relates to a cooling structure of a drive motor to cool the drive motor.

Embodiments provide a cooling apparatus of a drive motor that can improve cooling performance of the drive motor by directly injecting oil circulating in a channel in a support ring.

A cooling apparatus of a drive motor according to an exemplary embodiment of the present invention may include a supporter that is disposed in an inner wall of a housing, supports a stator of the drive motor, and forms an oil passage for moving cooling oil. The supporter is formed as a ring shape. An injector is connected with the oil passage of the supporter and injects the cooling oil in the oil passage into the stator.

A connection hole for connecting the oil passage and the injector may be formed in the supporter.

The connection hole may be formed toward the stator from the oil passage.

The connection hole may fluidly connect the oil passage and the injector, and may be formed in plural along an internal circumference of the supporter at a predetermined distance.

The injector may be connected with the connection hole, and include an injection pipe bent toward the stator.

The injection pipe may be bent toward a stator coil of the stator, and an injection nozzle may be disposed in an end of the injection pipe.

Another embodiment provides a cooling apparatus of a drive motor of concentrated winding split core type. The cooling apparatus may include a stator disposed in an inner wall of a housing. A first cooling route is disposed between the housing and the stator and forms an oil passage for moving cooling oil. A second cooling route is connected with the first cooling route and injects the cooling oil of the first cooling route into the stator.

The first cooling route may include a supporter which is disposed in an inner wall of a housing, supports a stator of the drive motor, and forms an oil passage for moving cooling oil, wherein the supporter is formed as a ring shape.

The first cooling route may indirectly cool the stator by cooling oil moving through the oil passage of the supporter.

The second cooling route may include an injector which is connected with the oil passage of the supporter and injects the cooling oil into the stator.

The second cooling route may directly cool the stator by the cooling oil injected by the injector.

The injector may include an injection pipe bent toward the stator.

The injection pipe may be bent toward a stator coil of the stator, and an injection nozzle may be disposed in an end of the injection pipe.

A connection hole for fluidly connecting the oil passage and the injection pipe may be formed in the supporter, and be formed in plural along an internal circumference of the supporter at a predetermined distance.

According to an exemplary embodiment of the present invention, since the cooling oil flowing through the oil passage of the supporter is supplied to the stator through the injector and the stator coil of the stator is directly cooled by the cooling oil, cooling performance of the drive motor can be improved.

Further, effects that can be obtained or expected from exemplary embodiments of the present invention are directly or suggestively described in the following detailed description. That is, various effects expected from exemplary embodiments of the present invention will be described in the following detailed description.

### BRIEF DESCRIPTION OF THE DRAWINGS

The drawings are provided for reference to explain an illustrative exemplary embodiment of the present invention, and the technical spirit of the present invention should not be interpreted to be limited to the accompanying drawings.

FIG. 1 is a cross-sectional schematic diagram illustrating a cooling apparatus of a drive motor according to an exemplary embodiment of the present invention.

FIG. 2 is a side view illustrating the cooling apparatus of the drive motor according to an exemplary embodiment of the present invention.

FIG. 3 is a perspective view illustrating a connection structure between a supporter and an injector applied to the cooling apparatus of the drive motor according to an exemplary embodiment of the present invention.

FIG. 4 is a cross-sectional schematic diagram illustrating the connection structure between a supporter and an injector applied to the cooling apparatus of a drive motor according to an exemplary embodiment of the present invention.

FIG. 5 is a drawing illustrating an operation of the cooling apparatus of a drive motor according to an exemplary embodiment of the present invention.

The following reference symbols can be used in conjunction with the drawings.

1 . . . housing

3 . . . stator

4 . . . stator core

5 . . . rotor

6 . . . stator coil

10 . . . first cooling route

11 . . . oil passage

20 . . . second cooling route

30 . . . supporter

35 . . . connection hole

50 . . . injector

51 . . . injection pipe

53 . . . injection nozzle

### DETAILED DESCRIPTION OF ILLUSTRATIVE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In order to clarify the present invention, parts that are not connected with the description will be omitted, and the same elements or equivalents are referred to by the same reference numerals throughout the specification.

Also, the size and thickness of each element are arbitrarily shown in the drawings, but the present invention is not necessarily limited thereto, and in the drawings, the thickness of layers, films, panels, regions, etc., are exaggerated for clarity.

Discriminating the names of components with the first, the second, etc. in the following description is for discriminating them for the same relationship of the components and the components are not limited to the order in the following description.

Throughout the specification, unless explicitly described to the contrary, the word “comprise” and variations such as “comprises” or “comprising”, will be understood to imply the inclusion of stated elements but not the exclusion of any other elements.

Further, the terms, “. . . unit”, “. . . part”, “. . . portion”, “. . . member” etc. used herein mean the unit of inclusive components performing at least one or more functions or operations.

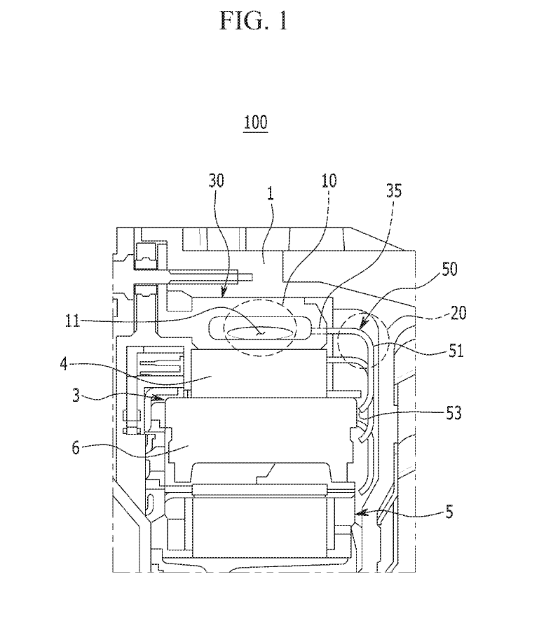

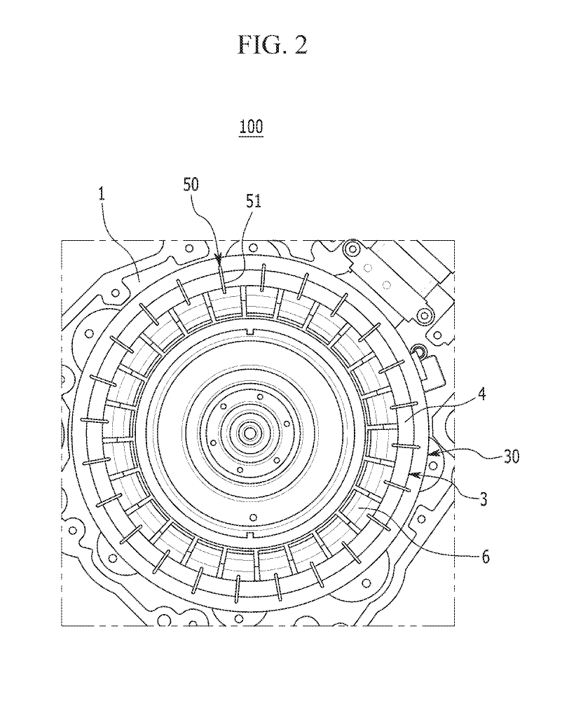

FIG. 1 is a cross-sectional schematic diagram illustrating a cooling apparatus of a drive motor according to an exemplary embodiment of the present invention. FIG. 2 is a side view illustrating the cooling apparatus of the drive motor according to an exemplary embodiment of the present invention.

Referring to FIG. 1 and FIG. 2, a drive motor according to an exemplary embodiment of the present invention may be applied to an electric vehicle or a hybrid vehicle. For example, the drive motor may be fixedly mounted to an automatic transmission of a hybrid vehicle.

The drive motor according to an exemplary embodiment of the present invention may include a permanent magnet synchronous motor (PMSM) or a wound rotor synchronous motor (WRSM).

The drive motor is fixedly mounted inside a motor housing 1. The drive motor includes a stator 3 for generating a magnetic flux and a rotor 5 arranged with a predetermined air gap to the stator 3 for rotating centered on a rotating shaft as a drive shaft. The housing 1 may include a transmission housing or a motor housing.

For example, the drive motor may be applied to an interior rotor type of synchronous motor in which the rotor 5 is disposed inside the stator 3. The stator 3 includes a stator core 4 of a split core type, and a stator coil 6 wound in a concentrated winding form.

A cooling apparatus 100 applied to the drive motor has a structure in which heat transmitted from the stator 3 of the drive motor to the motor housing 1 is dissipated through a cooling medium (for example, cooling oil).

Further, according to an exemplary embodiment of the present invention, it is possible to improve cooling performance of the drive motor by directly injecting the cooling oil to the stator 3 of the drive motor.

For this, the cooling apparatus of the drive motor according to an exemplary embodiment of the present invention includes a first cooling route 10 indirectly cooling the stator 3 by using the cooling oil, and a second cooling route 20 directly cooling the stator 3 by using the cooling oil.

The first cooling route 10 is provided between the housing 1 and the stator core 4, and includes an oil passage 11 for moving the cooling oil.

The first cooling route 10 includes a supporter 30 supporting the stator 3 and forming the oil passage 11 therein. The supporter 30 is formed as a ring shape. The supporter 30 is disposed in an inner wall of the housing 1 between the housing 1 and the stator core 4, and supports an external circumference of the stator core 4.

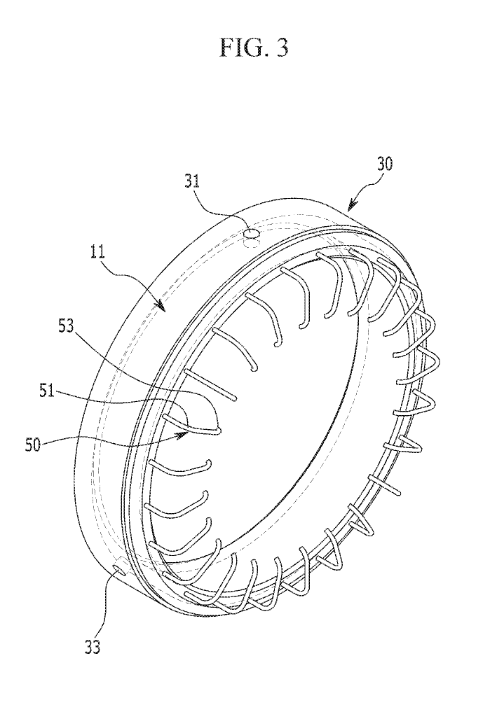

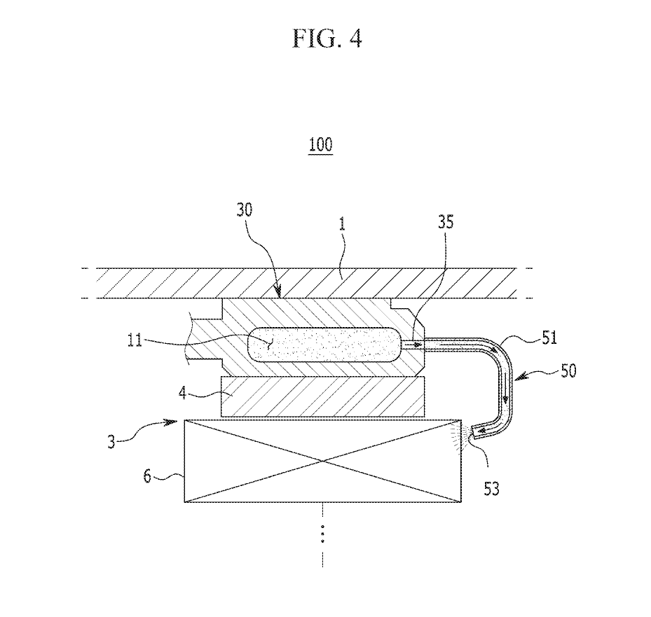

FIG. 3 is a perspective view illustrating a connection structure between a supporter and an injector applied to the cooling apparatus of the drive motor according to an exemplary embodiment of the present invention. FIG. 4 is a cross-sectional schematic diagram illustrating the connection structure between a supporter and an injector applied to the cooling apparatus of a drive motor according to an exemplary embodiment of the present invention.

Referring to FIG. 1 to FIG. 4, the supporter 30 is substantially formed as a ring shape. The supporter 30 includes an internal circumference, an external circumference, and side surfaces connection the internal circumference and the external circumference. The supporter 30 may be made of stainless steel having a thermal expansion coefficient similar to the stator core 4.

For example, the supporter 30 is forcefully inserted to an internal wall of the housing 1, the stator core 4 is forcefully inserted to the supporter 30 by supplying heat and fixed to an internal circumference of the supporter 30 by thermally inserted.

Since the stator core 4 and the supporter 30 having similar thermal expansion coefficient are assembled by thermal insertion method, assembly stability of the stator core 4 is improved and noise and vibration of the drive motor are reduced though the stator core 4 is heat-expanded during an operation of the drive motor.

In order to indirectly cool the stator core 4, the supporter 30 forms an oil passage 11 through which the cooling oil flows.

The oil passage 11 may be integrally formed in the supporter 30. The oil passage 11 may be formed in a channel type in the supporter 30. The cooling oil flows through the oil passage 11.

The supporter 30 is manufactured as a core-type low pressure casting to have the oil passage 11 formed therein as one unit with the securing member. That is, when a ring-shaped body of the supporter 30 is formed by the low pressure casting, the oil passage 11 may be formed in the ring-shaped body of the supporter 30.

The cooling oil stored in an oil pan is supplied to the oil passage 11 of the supporter 30 by a hydraulic pump. At this time, the cooling oil is cooled by a cooler and supplied to the oil passage 11. That is, the cooling oil is flows through the oil passage 11 by pumping pressure of the hydraulic pump, and the cooling oil circulates the oil passage 11 the oil pan.

Referring to FIG. 3, an inlet portion 31 into which the cooling oil flows is formed in the supporter 30, and an outlet portion 33 through which the cooling oil is exhausted is formed in the supporter 30.

The cooling oil flows through the oil passage 11 in the supporter 30 by the first cooling route 10 and heat generated in the stator coil 6 is transferred to the supporter 30 through the stator core 4 is dissipated to the housing 1 through the cooling oil, such that the stator 3 can be indirectly cooled by the cooling oil.

Meanwhile, the second cooling route 20 is fluidly connected with the oil passage 11 of the supporter 30 and directly injects a part of the cooling oil flowing though the oil passage 11 into the stator 3.

The second cooling route 20 includes an injector 50 which is connected with the oil passage 11 of the supporter 30 and directly injects the cooling oil into the stator 3.

In order to directly inject a part of the cooling oil flowing through the oil passage 11 of the supporter 30 into the stator 3 by the injector 50, a connection hole 35 is formed in the supporter 30. The connection hole 35 connects the oil passage 11 and the injector 50.

The connection hole 35 fluidly connects the oil passage 11 and is formed toward the stator 3. That is, the connection hole 35 fluidly connects the oil passage 11 and the injection pipe 51. The connection hole 35 functions as a connecting passage for injecting a part of the cooling oil flowing through the oil passage 11 to the injector 50. The connection hole 35 may be formed in plural, along an internal circumference of the supporter at a predetermined distance.

The injector 50 includes an injection pipe 51 connected with the connection holes 35 of the supporter 30, respectively, and bent toward the stator 3. The cooling oil flowing through the oil passage 11 of the supporter 30 is injected to the stator 3 through the connection hole 35 and the injection pipe 51.

In detail, the injection pipe 51 is connected with the connection hole 35 of the supporter 30, and bent toward the stator coil 6 of the stator 3. An injection nozzle 53 is disposed in an end of the injection pipe 51.

A part of the cooling oil flowing through the oil passage 11 of the supporter 30 is injected to the stator coil 6 of the stator 3 by the injection pipe 51, such that heat generated in the stator coil 6 is dissipated through the cooling oil and the stator 3 is cooled by the cooling oil.

In the specification of the present invention, the injectors 50 is connected with the connection hole 35 of the supporter 30 along the internal circumference of the supporter 30 and the cooling oil is injected to the stator coil 6 by the injector 50. However, the invention is not limited to the disclosed embodiments. The injector 50 may be disposed in a portion where cooling is required in the stator 3.

Hereinafter, an operation of the cooling apparatus of the drive motor according to an exemplary embodiment of the present invention will be described in detail with reference to accompanying drawings.

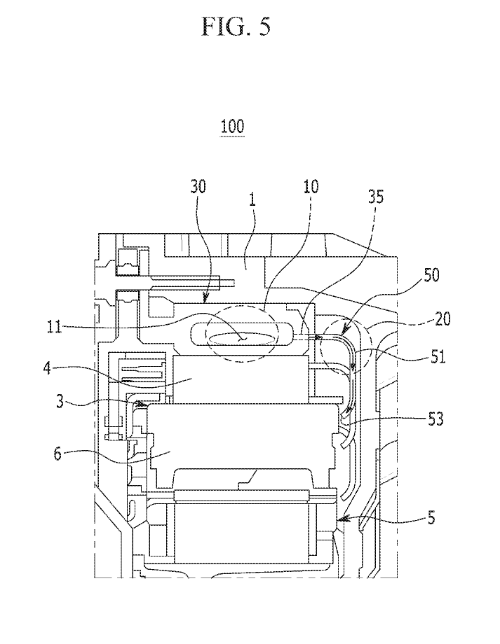

FIG. 5 is a drawing illustrating an operation of the cooling apparatus of a drive motor according to an exemplary embodiment of the present invention.

Referring to FIG. 1 to FIG. 5, the supporter 30 is forcefully inserted to an inner wall of the housing 1 and the stator core 4 of the stator 3 is thermally inserted to the internal circumference of the supporter 30, such that the stator core 4 is fixed to the housing 1 by the supporter 30.

The supporter 30 disposed between the inner wall of the housing 1 and an external circumference of the stator core 4, and forms the first cooling route 10 for moving the cooling oil flowing through the oil passage 11 therein.

The second cooling route 20 formed by the injection pipe 51 of the injector 50 connected with the connection hole 35 of the supporter 30, the injection pipe 51 bent toward the stator core 4, and the injection nozzle 53 disposed in an end of the injection pipe 51.

Meanwhile, heat is generated in the stator coil 6 of the stator 3 during an operation of the drive motor, the heat generated in the stator coil 6 is transferred to the housing 1 through the stator core 4 and dissipated outside. Further, the cooling oil stored in the oil pan is supplied to the cooler by an operation of the hydraulic pump and cooled, and the cooled cooling oil is supplied to the oil passage 11 of the supporter 30.

Accordingly, the cooling oil flows through the oil passage 11 formed in the supporter 30, and heat generated in the stator coil 6 is transferred to the supporter 30 through the stator core 4 and dissipated to the housing 1 by the cooling oil. Therefore, it is possible to indirectly cool the stator 3 by the cooling oil.

In this process, a part of the cooling oil flowing through the oil passage 11 of the supporter 30 is injected to the injection pipe 51 through the connection hole. Then, the cooling oil is injected to the stator coil 6 of the stator 3 through the injection nozzle 53 of the injection pipe 51.

Accordingly, since a part of the cooling oil flowing through the oil passage 11 of the supporter 30 is injected to the stator coil 6 of the stator 3 through the injection pipe 51 and heat generated in the stator coil 6 is dissipated by the cooling oil, the stator 3 can be directly cooled by the cooling oil. Here, the cooling oil is pooled in a lower portion of the housing 1, cools a lower part of the stator 3, and is recirculated to the oil pan by the hydraulic pump.

As described above, according to an exemplary embodiment of the present invention, in the first cooling route 10, the stator 3 of the drive motor can be indirectly cooled by the cooling oil flowing through the oil passage 11 of the supporter 30.

Further, in the second cooling route 20, since a part of the cooling oil flowing through the oil passage 11 of the supporter 30 is injected to the stator coil 6 of the stator 3 by the injector 50, the stator 3 of the drive motor can be directly cooled.

That is, the stator 3 is indirectly cooled through the supporter 30 of the first cooling route 10 and the stator 3 is directly cooled through the injector 50 of the second cooling route 20, cooling performance of the drive motor can be maximized.

Further, since the cooling oil is injected to the stator coil 6 of the stator 3 by the injector 50 and directly cools the stator coil 6, cooling performance of the drive motor can be increased without increasing cooling area of the supporter 30.

Therefore, since size of the drive motor need not be increased to improve cooling performance of the drive motor, torque density of the drive motor can be increased and manufacturing cost of the drive motor can be reduced.

Also, since a part of the cooling oil flowing through the oil passage 11 of the supporter 30 is directly injected to the stator coil 6 of the stator 3 by the injector 50 and additional parts for supplying the cooling oil to the injector 50 does not need, it is possible to reduce manufacturing cost of the cooling apparatus of the drive motor.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A cooling apparatus for a drive motor, the cooling apparatus comprising:
a supporter disposed in an inner wall of a housing, the supporter configured to support a stator of the drive motor and form an oil passage for moving cooling oil, wherein the supporter is formed as a ring shape; and
an injector connected with the oil passage of the supporter, the injector configured to inject the cooling oil in the oil passage into the stator.

2. The cooling apparatus of claim 1, wherein the supporter includes a connection hole for connecting the oil passage and the injector.

3. The cooling apparatus of claim 2, wherein the connection hole is formed toward the stator from the oil passage.

4. The cooling apparatus of claim 3, wherein the connection hole fluidly connects the oil passage and the injector.

5. The cooling apparatus of claim 4, wherein the connection hole is formed in plural along an internal circumference of the supporter at a predetermined distance.

6. The cooling apparatus of claim 2, wherein the injector is connected with the connection hole, and includes an injection pipe bent toward the stator.

7. The cooling apparatus of claim 6, wherein the injection pipe is bent toward a stator coil of the stator, and an injection nozzle is disposed in an end of the injection pipe.

8. A cooling apparatus of a drive motor of concentrated winding split core type, the cooling apparatus comprising:
a stator disposed in an inner wall of a housing;
a first cooling route disposed between the housing and the stator, the first cooling route forming an oil passage for moving cooling oil; and
a second cooling route connected with the first cooling route so that the cooling oil of the first cooling route can be injected into the stator.

9. The cooling apparatus of claim 8, wherein the first cooling route includes a supporter that is disposed in an inner wall of a housing, supports a stator of the drive motor, and forms an oil passage for moving cooling oil.

10. The cooling apparatus of claim 9, wherein the supporter is formed as a ring shape.

11. The cooling apparatus of claim 9, wherein the first cooling route is configured to indirectly cool the stator with cooling oil moving through the oil passage of the supporter.

12. The cooling apparatus of claim 9, wherein the second cooling route includes an injector that is connected with the oil passage of the supporter and is configured to inject the cooling oil into the stator.

13. The cooling apparatus of claim 12, wherein the second cooling route is configured to directly cool the stator with the cooling oil injected by the injector.

14. The cooling apparatus of claim 12, wherein the injector includes an injection pipe bent toward the stator.

15. The cooling apparatus of claim 14, wherein the injection pipe is bent toward a stator coil of the stator and wherein an injection nozzle is disposed in an end of the injection pipe.

16. The cooling apparatus of claim 15, wherein the supporter includes a connection hole for fluidly connecting the oil passage and the injection pipe.

17. The cooling apparatus of claim 16, wherein the supporter is formed as a ring shape and wherein the connection hole is formed in plural along an internal circumference of the supporter at a predetermined distance.
